(19) United States
(12) Patent Application Publication
(10) Pub. No.: US 2009/0263551 A1
(43) Pub. Date: Oct. 22, 2009

(54) Devices and Methods for Mixing and/or Kneading Food Products

(76) Inventors: Marinus Arie Van Praag, Bunde (NL); Gilis Anne-Maria Victor Lekner, Vilt (NL)

Correspondence Address: Maier & Maier, 1000 Duke Street, Alexandria, VA, 22314, US

(21) Appl. No.: 11/922,349

(22) PCT Filed: Jun. 12, 2006
(86) PCT No.: PCT/NL2006/000287

§ 371 Date: Mar. 9, 2009

(30) Foreign Application Priority Data
Jun. 17, 2005 (NL) 1029273

(51) Int. Cl. A21C 1/06; A23L 1/48; A21C 1/10; A21C 1/14

(52) U.S. Cl. 426/519; 366/97; 366/86; 366/76.6; 366/82; 366/76.2; 366/77

(57) ABSTRACT

A device for mixing and/or kneading food products is provided with a container having an inlet, an outlet as well as at least two counter-rotating shafts that extend substantially in the longitudinal direction of the container. Each shaft is fitted with at least one tool, which tool comprises at least one bar that helically surrounds the shaft, which bar is fixed to the shaft by means of spacers. The bar extends substantially as one whole over an operative area of the shaft.

The invention relates to devices for mixing and/or kneading food products, which device is provided with a container having an inlet, an outlet as well as at least one rotary shaft that extends substantially in the longitudinal direction of the container, which shaft is fitted with at least one tool.

The invention further relates to methods for mixing and/or kneading food products, wherein the food products are mixed and/or kneaded in a container by means of at least one rotary shaft that extends substantially in the longitudinal direction of the container, which shaft is fitted with at least one tool.

With such a device as known from EP 0 729 303, which is suitable for kneading bread dough, the device comprises a tub-shaped container, which is open at the upper side thereof. Two identical counter-rotating shafts are disposed in the container, which shafts are fitted with tools in the form of U-shaped bracket elements. The dough that is present in the container is kneaded by means of said bracket elements. In use, the dough is transported from the inlet to the outlet in the container.

A drawback of the above-described device is that the velocity at which the dough is conveyed through the container mainly depends on the amount of dough to be treated that is introduced into the container via the inlet. The fact is that it has become apparent in practice that the U-shaped bracket elements hardly contribute to the velocity at which the dough is conveyed in the container.

Another drawback is the fact that the shafts are fitted with separate U-shaped bracket elements, each of which bracket elements individually exerts a force on the shaft. Because of the fact that separate bracket elements are provided, the forces being exerted on the shaft during the kneading operation are distributed relatively inadequately over the shaft, so that there is a risk of the shaft being damaged.

Yet another drawback is the fact that the container is open at the upper side thereof, so that in the first place impurities may find their way into the container from outside and in the second place only air that is present in the space in which the device is disposed is supplied to the dough to be kneaded.

The object of the present invention is to provide an improved device.

This object is accomplished with the device according to the invention in that the container comprises two counter-rotating shafts, each of which is fitted with at least one tool, which tool comprises at least one bar that helically surrounds the shaft, which bar is fixed to the shaft by means of spacers, with the bar extending substantially as one whole over an operative area of the shaft.

The term operative area is understood to mean that part of the container in which the food products are mixed and/or kneaded. By constructing the bar in one piece, the forces that are exerted on the bar are evenly distributed over the entire rotary shaft, as a result of which the shaft will break less easily and a thinner construction of the shaft may be used, if desired. Since the bar extends as one whole over the operative area of the shaft, the contact area between the bar and the food product to be treated is relatively large.

Yet another embodiment of the device according to the invention is characterised in that the number of spacers per unit length on the two rotary shafts is larger near the inlet than near the outlet.

The spacers serve a dual purpose with the tool according to the invention. In addition to fixing the bar to the shaft, the spacers contribute to the mixing of the food product. When the food products are not mixed yet at the inlet of the container, the food products can be adequately mixed in a simple manner by providing more spacers in the part of the shaft that is located near the inlet.

Yet another embodiment of the device according to the invention is characterised in that the number of spacers or the spacing therebetween is different for each of the two rotary shafts.

Making the counter-rotating shafts different from each other achieves that the food product is mixed and/or kneaded asymmetrically, as a result of which the quality of the food product is improved in a simple manner.

Another embodiment of the device according to the invention is characterised in that the device comprises a lifting mechanism for tilting the container.

Tilting the device by means of the lifting mechanism makes it possible to control the velocity at which the food product is conveyed through the container by utilising the force of gravity that acts on the food product present in the container. Moreover, by tilting the container in a random direction, the food product to be treated can be moved within the container in such a manner that an optimally mixed and/or kneaded food product can be obtained. The device is in particular suitable for treating dough or meat products such as gyros.

One embodiment of the device according to the invention is characterised in that the container can be tilted at an angle with respect to the horizontal by means of the lifting mechanism.

In this way the conveying velocity of the food product in the container between the inlet and the outlet thereof can be determined fairly precisely by controlling the angular velocity of the lifting mechanism. This makes it possible to opt for relatively quick tilting or for gradual tilting, for example, in dependence on the specific food product to be treated. The improved possibility of controlling the conveying velocity of the food product through the container makes it possible to treat different types of food product while using a container of “standard dimensions”, since the residence time in the container can be increased as well as decreased.

Another embodiment of the device according to the invention is characterised in that the container has a bottom that comprises a first part located near the inlet and a second part located near the outlet, wherein the container can be moved by means of the lifting mechanism from a first position, in which said first part is positioned lower than the second part, to a second position, in which said first part is positioned higher than said second part.

By tilting the container to the first position, the newly introduced food products can be adequately mixed in the first part before they are moved in the direction of the outlet as a result of the container being gradually tilted to the second position. The device may also be tilted to a random position, such as the horizontal position, for example. The second position may be used in particular for emptying the container, so that the container can then be easily cleaned, for example.

Yet another embodiment of the device according to the invention is characterised in that the angle through which the container can be tilted is maximally 40°, preferably 30°.

Yet another embodiment of the device according to the invention is characterised in that the container is of closed construction between the inlet and the outlet.

By designing the container to be of closed construction between the inlet and the outlet, it is ensured in a simple manner that no impurities will find their way into the container from outside As a result, all the safety and hygiene requirements can be readily met.

Yet another embodiment of the device according to the invention is characterised in that the closed container is provided with an air supply means for supplying conditioned air that is required for mixing and/or kneading the food products.

By supplying air that has been conditioned as regards the amount to be supplied, the humidity level, the temperature, the composition etc thereof, the air to be supplied can be optimized to the food product to be treated and the quality of the final product can be improved in a simple manner.

Yet another embodiment of the device according to the invention is characterised in that a scraper is provided round the shaft near the outlet.

Accumulations of the relatively sticky mass of mixed and/or kneaded food products near the outlet of the container can be readily prevented by providing a scraper near the outlet, because the scraper scrapes said mass from the rotating tool and from the shaft. The shape of the scraper is preferably adapted to those of the shaft and the tool mounted thereon. It has surprisingly been found that the use of a scraper has a very positive effect on the conveying velocity of the mixture/dough through the container.

Yet another embodiment of the device according to the invention is characterised in that at least one stop disc is mounted on the shaft.

The mass of dough and mixture can be stopped In a simple manner by using a stop disc, before the mass can reach the shaft bearings. The mass will accumulate against the stop disc, after which the scraper, for example, will convey the mass towards the outlet.

Yet another embodiment of the device according to the invention is characterised in that a moisturising device is provided near or in the inlet.

The moisturising device supplies a fluid through a ring or the like disposed within the inlet, which fluid is contacted with the powdery raw materials being supplied through the inlet in the form of drops or a spray. In this way a premixing of fluid and the powdery material takes place upon entry of the raw materials. Said premixing makes it possible to use a smaller container or, in the case of an unchanged length of the container, leads to an improved final mixing result.

The invention will now be explained in more detail with reference to the appended figures, in which;

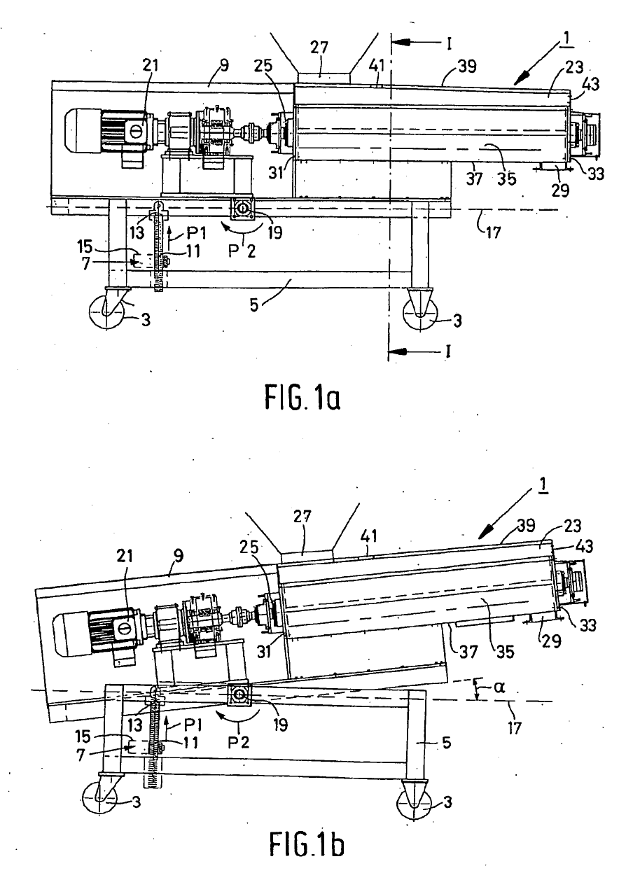

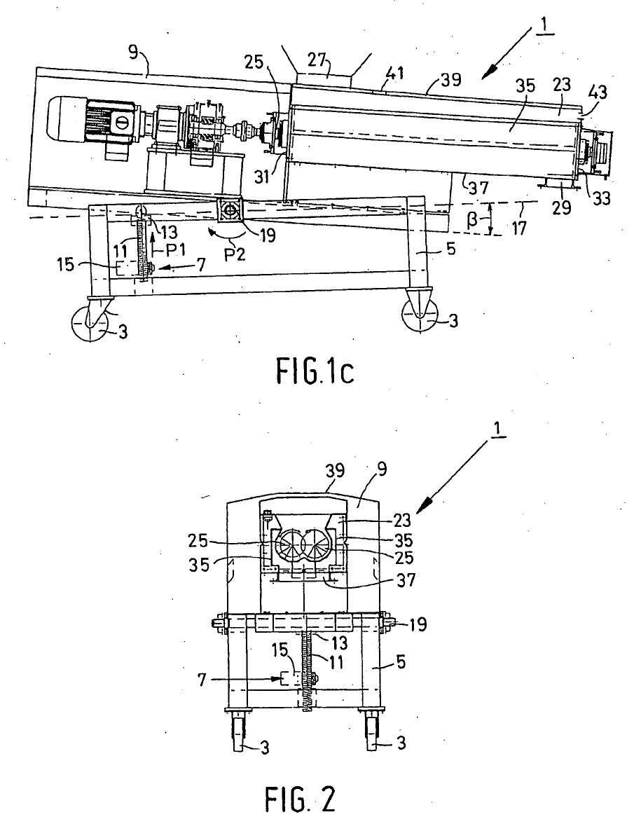

FIGS. 1a-c are side views of a device according to the invention, showing a holder of the device in a number of different tilted positions;

FIG. 2 is a sectional view I-I of the device according to the invention that is shown in FIG. 1;

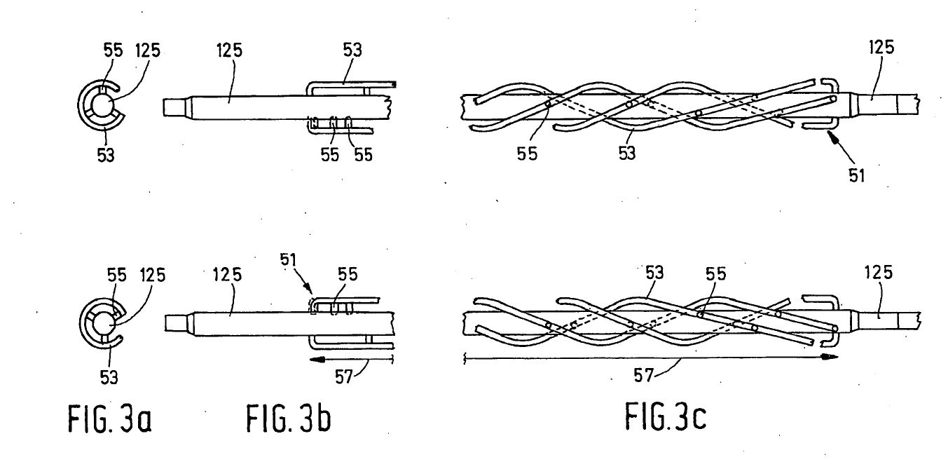

FIGS. 3a, 3b and 3c are a front view, a schematic view and a top plan view, respectively, of a first embodiment of shafts fitted with tools of the device according to the invention;

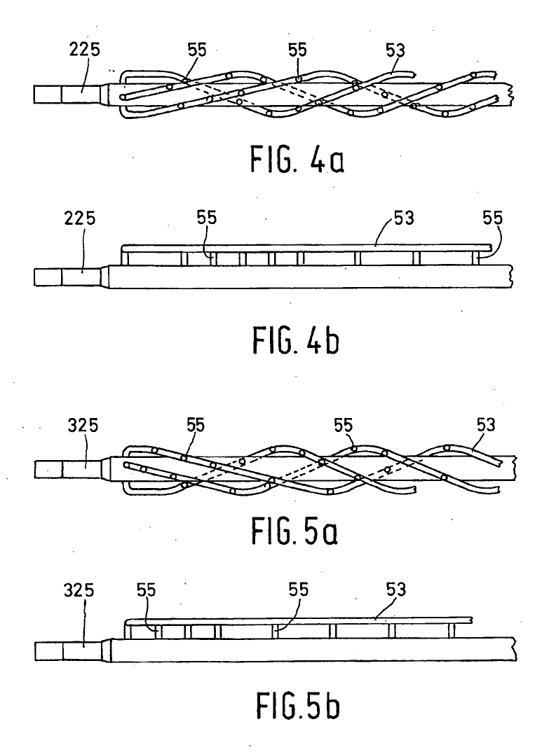

FIGS. 4a and 4b are a top plan view and a schematic view, respectively, of a second embodiment of a shaft fitted with a tool of the device according to the invention;

FIGS. 5a and 5b are a top plan view and a schematic view, respectively, of a third embodiment of a shaft fitted with a tool of the device according to the invention;

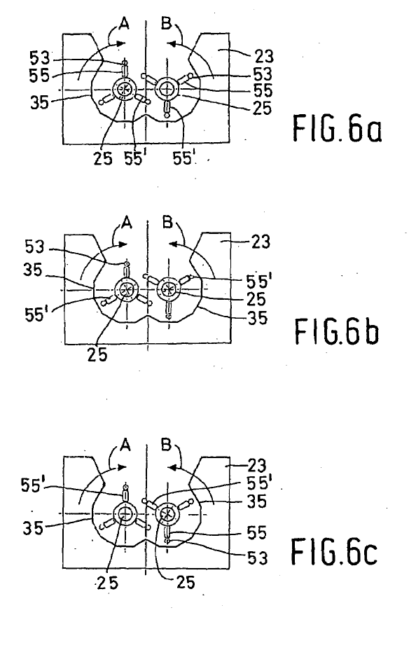

FIGS. 6a-c are front views showing the operation of the device according to the invention during various operating steps; and

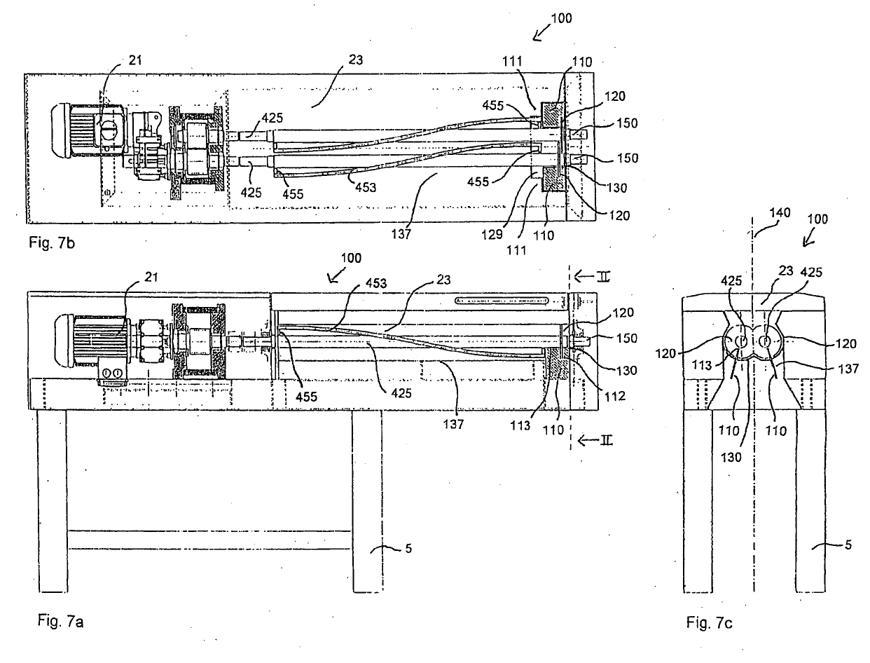

FIGS. 7a-c are views of an alternative device according to the invention.

Like parts are indicated by the same numerals in the various figures.

FIGS. 1a-c are side views of the device 1 according to the invention for mixing and/or kneading a food product, showing a container of the device in a number of different tilted positions thereof, and FIG. 2 is a sectional view I-I of the device 1 according to the invention that is shown in FIG. 1a. The device 1 comprises a frame 5 to be moved on wheels 3, on which frame 5 a lifting mechanism 7 as well as a holder 9 are mounted.

The lifting mechanism 7 is provided with a spindle 11, for example a ball circulating spindle, which is mounted to the frame 5 and which is connected to the holder 9 by means of angle compensation means 13. The spindle 11 can be moved in the direction indicated by the arrow P1 and in the opposite direction by means of an electric and/or hydraulic drive unit 15.

In FIG. 1a, the holder 9 takes up a position in which it extends parallel to the horizontal 17. The holder 9 is pivoted in a direction indicated by the arrow P2 about a pivot pin 19 to the first tilted position that is shown in FIG. 1b, in which the holder 9 includes an angle a with the horizontal, by moving the spindle 11 from the horizontal position that is shown in FIG. 1 in a direction opposite the direction indicated by the arrow P1 by means of the drive unit 15. The holder 9 is pivoted in the opposite direction of the arrow P2 about the pivot pin 19, back to the horizontal position that is shown in FIG. 1a, by moving the holder 9 from the position that is shown in FIG. 1b in the direction indicated by the arrow P1 by means of the spindle 11. From said horizontal position, the holder 9 can be pivoted further about the pivot pin 19 in the opposite direction of the arrow P2 to the position that is shown in FIG. 1c, in which the holder 9 includes an angle β with the horizontal 17, by moving the spindle 11 further in the direction indicated by the arrow P1.

Preferably, the angles α and β are maximally 20°, more preferably maximally 15°, for mixing andlor kneading.

Disposed within the holder 9 are a driving mechanism 21 and a container 23. Shafts 25 disposed within the container 23 can be rotated in opposite directions at a speed to be varied by means of the driving mechanism 21.

The container 23 is provided with an inlet 27 for filling the container 23 with the food product to be treated and with an outlet 29 for discharging the food product that was treated. The container 23 comprises side walls 31, 33, side walls 35 extending in the longitudinal direction between the side walls 31, 33, a bottom 37 provided with the outlet 29 and a cover 39 provided with the inlet 27. The rotary shafts 25 extend through the side wall 31 disposed near the inlet 27 and through the side wall 33 disposed near the outlet 29, covering the full length of the container 23. The cover is furthermore provided with an air inlet opening 41 and with an air outlet opening 43 for supplying and discharging air from the container 23, which air inlet opening 41 and which air outlet opening 43 may be connected to an air supply means (not shown) for supplying a controlled amount of air that has been conditioned for humidity, composition and temperature, for example.

Disposed within the inlet 27 is furthermore a moisturising device (not shown), for example an annular, apertured hose.

The operation of the device 1 is as follows.

The moment the food product is introduced into an empty container 23 via the inlet 27, the shafts 25 and the tools mounted thereon rotate substantially without load, because the container 23 is not sufficiently filled yet. By disposing the container 23 at an angle a in a first position, the part of the container 23 that is located near the inlet 27 will be filled relatively quickly, so that the tool will sooner be able to treat the food product in an effective manner than would be possible with the container 23 in the horizontal position. Once the container 23 is filled with food products to a sufficient degree, the holder 9 can be gradually tilted in the direction indicated by the arrow P2 about the pivot pin 19 by operating the lifting mechanism 7, for example until the holder 9 extends parallel to the horizontal 17. Following that, the holder 9 can be tilted further in the direction indicated by the arrow P2 about the pivot pin 19 by means of the lifting mechanism 7 until the holder 9 has reached the second position (FIG. 1c). In the second position, the conveying velocity of the food products in the container 23 in the direction of the outlet 29 will be increased because the food products are conveyed through the container 23 in the direction of the outlet under the influence of the force of gravity in addition to the usual forces.

When the container 23 is to be emptied for maintenance, the selected angle β may be much larger than 20°, so that the container 23 can be emptied quickly under the influence of the force of gravity.

The raw materials/food products being supplied can be moisturised with a fluid in the form of drops or a spray by the moisturising device upon entering the container 23. By moisturising the raw materials/food products upon entry, a premixing effect is realised prior to the actual mixing by the tool and the shafts 25.

FIGS. 3-5 are views of various embodiments of the shafts 125, 225, 325 to be used in the device 1 according to the invention.

Each shaft 125 is fitted with a tool 51 made up of three bars 53 that helically surround the shaft 125 (FIG. 3c), which bars are fixed to the shaft 125 by means of spacers 55. The bars 53 extend substantially as one whole over an operative area 57 of the shaft 125. The operative area 57 is relatively large and comprises the area in which the bar 53 and the food products present in the container 23 are actually in contact with each other. During rotation of the shafts 125, the kneading of the food products present in the container 23 is mainly carried out by the bars 53, whilst the mixing of said food products is mainly carried out by the spacers 55. In use, the shafts 135 rotate in opposite directions. The two shafts 125 are mirror images of each other.

FIGS. 3b, 4b and 5b are schematic views of parts of the shafts 125, 225, 325, in which function the number and the positions of the spacers 55 of the tool 51 on the shafts 125, 225, 325 are clearly shown. The tools on the shafts 125 that are shown in FIG. 3b comprise the same number of spacers 55, which are spaced apart by a fixed distance (pitch). The shafts 125 used in the container 23 are mirror images of each other.

The shaft 225 that is shown in FIG. 4b comprises a number of closely spaced spacers 55 and a number of spacers 55 which are spaced more widely. Like in FIG. 3, the spacers 55 disposed on the shafts connect three bars 53 to the shafts 225.

The shaft 325 that is shown in FIG. 5b comprises more spacers 55 per unit length near the inlet 27 than near the outlet 25. This enhances the mixing function of the tool 51 near the inlet 27. In this case, too, the spacers 55 on the shafts 325 connect three bars 53 to the shafts 325, like in FIG. 3b.

The shaft 225 is preferably combined with the shaft 325 in the container 23. By using two shafts 225 and 325 of different construction, whose spacers 55 are not arranged in mirror symmetry, in contrast to the bars 53 thereof, which are arranged in mirror symmetry, as shown in FIG. 3c, the spacers realise an asymmetric mixing effect in the food products to be treated, which has a positive effect on the quality of the final product.

FIGS. 6a-c are front views of three different operating steps in the kneading process that takes place in the container 23. Disposed within the container are counter-rotating shafts 125 extending substantially in the longitudinal direction of the container 23 are (FIG. 3a-c). FIGS. 6a-c schematically represent the operating steps in the kneading process by following two spacers 55′.

In the operating step that is shown in FIG. 6a, the spacers 55′ are moved apart in the directions indicated by the arrows A and B, thereby pulling the food products, called dough hereinafter, apart. In an operating step that is shown in FIG. 6b, the dough is moved along the walls 35 of the container 23 by means of the spacers 55′, introducing energy into the dough on account of the friction the dough experiences between the walls 35 and the spacers 55′. In the operating step that is shown in FIG. 6c, the spacers 55′ are moved towards each other, thereby compressing the dough that is present therebetween, after which the cycle of the various operating steps is complete and the spacers 55′ will again be moved apart in a manner that is shown in FIG. 6a.

The above is a schematic representation and it stands to reason that the various operating steps shown in FIGS. 6a-c are carried out simultaneously along the length of the operative area 57 by means of the helical bars 53.

FIGS. 7a and 7b are a side view and a top plan view, respectively, and FIG. 7c is a sectional view II-II of a device 100 as shown in FIG. 7a for mixing and/or kneading a food product. The device 100 is different from the device 1 in that the device 100 is provided with two scrapers 110 and two stop discs 120. Furthermore, the outlet 129 of the device 100 has been made smaller by the provision of two scraper flanges 111, which are integrated in the bottom 137 of the container 23.

Tools in the form of bars 453 that helically surround the shafts 425 are fixed to said shafts by means of spacers 455.

The scraper 110 is preferably a relatively thin metal plate that is rigidly attached to the wall(s) of the container 23. The square scraper 110 is provided with a recess 112 for scraping off the stop discs 120.

The scraper 110 furthermore has an edge 113, which is separated from the shaft 425 only by a gap 130. The spacing between the edge 113 and the shaft 425 is maximally 2.5 cm. Furthermore, the spacing between the bar 453 and the scraper flanges 111 and between the bar 425 and the scraper 110 is likewise maximally 2.5 cm, which is also the maximum spacing between the stop disc 120 and the scraper 110.

In use, the two scrapers 110 scrape the relatively sticky mixed and/or kneaded food products from the shafts 425, the bar 453 and the stop discs 120. The scraper 110 is oriented at an angle with respect to the vertical 140. Because of this orientation, the scraper 110 discharges the food products to the outlet 129 in an efficient manner. The scraper 110 furthermore functions to discharge the prepared food product in a controlled manner.

The stop discs 120 prevent remainders of the food products from reaching the bearings 150 of the shafts 425. The two discs 120 are arranged in mutually staggered relationship on the shafts 425, making it possible to select a diameter of the discs 120 such that the discs 120 overlap (see FIG. 7c), thereby preventing food product remainders from moving between the discs 120 in the direction of the bearings 150.

Instead of providing the scraper 110 with scraper flanges 111 it is also possible to use a larger scraper 110. The outlet of the container 23 is made up of a rectangular opening without scraper flanges 111 in that case, whilst the scraper has been enlarged by an amount corresponding to the surface area of the scraper flanges 111. In that case the scraper (not shown) will have a hexagonal shape that corresponds to that of a rectangle from one corner of which a square section has been removed.

The aspects that are shown in FIGS. 7a-c, such as the scraper 110, the tool and the stop discs 120, can also be used in combination with the aspects shown in the preceding figures, and vice versa.

The device 1 is suitable for use in a batch process as well as in a continuous process. Both processes require a specifically controlled tilting of the holder 9 by means of the lifting mechanism 7, partially in dependence on the product to be prepared.

Said tilting of the holder 9 can be carried out by operating the lifting mechanism either manually or in a software-controlled manner, with the conveying velocity depending on the selected angle of tilt.

The supply of air and the discharge of air may take place at various locations in the container 23. It is for example possible to provide an air inlet opening before the inlet 27, i.e. between the side wall 31 of the container 23 located near the driving mechanism 21 and the inlet 27, for squirting air under pressure into the container. The resulting venturi effect creates a sub-atmospheric pressure in the container 23 near the inlet 27, as a result of which the (e.g. powdery) food products to be supplied via the inlet 27 are drawn into the container 23, as it were.

Preferably it is possible to control the amount of air to be supplied, a typical range for the air flow ranging between 50 and 400 cubic meters per hour. The pressure inside the container is more or less the same as the atmospheric pressure. The oxygen content of the air to be supplied to the food product may be increased, making it possible to realise an optimum oxygen exchange between the food product and the air. Furthermore it is possible to vary the humidity and the temperature of the air to be supplied to the food product.

The number of revolutions of the rotary shafts 19 can be varied by means of the driving mechanism 15, thereby making it possible to control the amount of friction energy that is released during the kneading and/or mixing process.

The device 1 can be used as a mixer or a kneader or as a mixer and a kneader. If the device 1 is used as a mixer, the number of spacers 55 on the shafts 25 must be relatively high, whilst the number of spacers 55 on the shafts 25 may be relatively low if the device is used as a kneader, because it is mostly the bar 53 that does the kneading. If a device 1 is used both for mixing and for kneading, the number of spacers 55 near the inlet 27 must be relatively large in comparison with the number of spacers 55 near the outlet 29.

The function of the bar 53 can be changed by varying the pitch of the helical bar 53. When a relatively large pitch is used, the bar 53 will extend substantially axially, in which condition the bar 53 will hardly contribute to a mixing process possibly to be carried out, but in which it will be suitable mainly for kneading the food product. When the pitch of the helical bar 53 is reduced, the bar 53 will extend substantially tangentially with respect to the shaft 25, in which condition the bar 53 is suitable mainly for mixing the food product.

Any lifting mechanism that is currently known to those skilled in the art may be used for the lifting mechanism 7, such as two pistons to be moved within cylinders, which are mounted to the frame on either side of the pivot pin, wherein a tilting movement in one direction or the other can be effected by suitably driving the piston-cylinder combination.

To reduce the adherence of the food products to the shafts and the tool, the shafts and the tool may also be provided with a smooth layer, such as a Teflon layer, for example. Furthermore, the surface of the shafts and the tool may be made smoother through the application of nanotechnology.

The bar-shaped tool that extends as one whole over the operative area of the shaft has a relatively large diameter, as a result of which the tool is relatively sturdy and inflexible.

1-26. (canceled)

27. A device for mixing and/or kneading food products, comprising:
a container having an inlet and an outlet; and
at least one rotary shaft extending substantially in the longitudinal direction of the container, the at least one rotary shaft fitted with at least one tool.

28. The device of claim 27 wherein the at least one rotary shaft is two counter-rotating rotary shafts, each shaft fitted with at least one tool, each tool having at least one bar helically surrounding the shaft, each bar fixed to the shaft by a plurality of spacers, wherein each bar extends substantially as a whole over an operative area of the shaft.

29. The device of claim 28 wherein the plurality of spacers on the two rotary shafts is characterized by a larger number of spacers per unit length near the inlet than near the outlet.

30. The device of claim 28 wherein the plurality of spacers on each of the rotary shafts is characterized by a different number of spacers or differing spacing therebetween.

31. The device of claim 27 wherein the container is of a closed construction between the inlet and the outlet.

32. The device of claim 31 wherein the closed container is provided with an air supply for supplying conditioned air.

33. The device of claim 27, further comprising:
a lifting mechanism for tilting the container.

34. The device of claim 33 wherein the container can be tilted at an angle with respect to the horizontal by the lifting mechanism.

35. The device of claim 33 wherein the container has a bottom, the bottom having a first part located near the inlet and a second part located near the outlet, wherein the container can be moved by the lifting mechanism from a first position, the first part being positioned lower than the second part, to a second position, the first part being positioned higher than the second part.

36. The device of claim 34 wherein the angle through which the container can be tilted is maximally 40°, preferably 30°.

37. The device of claim 27, further comprising:
a scraper provided around the at least one rotary shaft near the outlet.

38. The device of claim 27, further comprising:
at least one stop disc mounted on the at least one rotary shaft.

39. The device of claim 27, further comprising:
a moisturizing device provided near or in the inlet.

40. A device for mixing and/or kneading food products, comprising:
a container having an inlet and an outlet;
at least one rotary shaft extending substantially in the longitudinal direction of the container, the at least one rotary shaft fitted with at least one tool; and
a scraper provided around the at least one rotary shaft near the outlet.

41. The device of claim 40, further comprising:
at least one stop disc mounted on the at least one rotary shaft.

42. The device of claim 40 wherein the shape of the scraper is adapted to the at least one tool with a space between the tool and the scraper being maximally 2.5 cm.

43. The device of claim 40 wherein a space between the shaft and the scraper is maximally 2.5 cm.

44. The device of claim 40 wherein the at least one rotary shaft is two counter-rotating rotary shafts, each shaft fitted with at least one tool, each tool having at least one bar helically surrounding the shaft, each bar fixed to the shaft by a plurality of spacers, wherein each bar extends substantially as a whole over an operative area of the shaft.

45. The device of claim 44, further comprising:
at least one stop disc mounted on each shaft, the stop discs mounted in a mutually staggered relationship on the two shafts resulting in the stop discs partially overlapping.

46. The device of claim 40, further comprising:
a moisturizing device provided near or in the inlet.

47. A method for mixing and/or kneading food products, comprising:
providing a device with a container having an inlet and an outlet;
providing a moisturizing device near or in the inlet;
mixing food products in the container by means of at least one rotary shaft that extends substantially in the longitudinal direction of the container; and
moisturizing the food products being supplied through the inlet.

48. The method of claim 47, further comprising:
tilting the container between a first position and a second position by means of a lifting mechanism.

49. The method of claim 47, further comprising:
supplying conditioned air to the container.

50. A method for mixing and/or kneading food products, comprising:
providing a container with at least one bar that helically surrounds at least one rotary shaft, each bar extending substantially as a whole over an operative area of the shaft; and
mixing and/or kneading food products in the container by means of the at least one rotary shaft that extends substantially in the longitudinal direction of the container, wherein friction energy is introduced into the food products between the walls of the container and each bar as a result of the rotation of each bar.

51. The method of claim 50, furthering comprising:
tilting the container between a first position and a second position by means of a lifting mechanism.

52. The method of claim 50, further comprising:
supplying conditioned air to the container.

53. The method of claim 50, further comprising:
providing a moisturizing device near or in the inlet; and
moisturizing the food products being supplied through the inlet.
